(19) United States
(12) Patent Application Publication
(10) Pub. No.: US 2016/0150011 A1
(43) Pub. Date: May 26, 2016

(54) MEDIA OUTPUT DEVICE TO TRANSMIT AND SYNCHRONIZE PLAYBACK OF A MEDIA CONTENT STREAM THAT IS RECEIVED OVER A POINT-TO-POINT CONNECTION ON MULTIPLE INTERCONNECTED DEVICES

(71) Applicant: QUALCOMM Incorporated, San Diego, CA (US)

(72) Inventors: Johan Le Nerriec, San Francisco, CA (US); Jehan Gérard Bing, Menlo Park, CA (US); Judah John Menter, Austin, TX (US); Craig Furman, Oakland, CA (US); Gaurav Mittal, San Francisco, CA (US)

(21) Appl. No.: 14/946,561

(22) Filed: Nov. 19, 2015

Related U.S. Application Data
(60) Provisional application No. 62/085,195, filed on Nov. 26, 2014.

(51) Int. Cl. H04L 29/08

(52) U.S. Cl. CPC H04L 67/1095; H04L 67/104; H04L 67/1051

(57) ABSTRACT

Examples described herein provide for a media output device to transmit and synchronize playback of a media content stream that is received over a point-to-point connection on multiple interconnected devices at one time.

### RELATED APPLICATIONS

This application claims benefit of priority to Provisional U.S. Patent Application No. 62/085,195, filed Nov. 26, 2014; the aforementioned priority application being hereby incorporated by reference in its entirety.

### TECHNICAL FIELD

Examples described herein relate to a media output device, and more specifically, to a media output device for transmitting and synchronizing playback of a media content stream that is received over a point-to-point connection on multiple interconnected devices.

### BACKGROUND

Media output devices can connect to source devices using a point-to-point connection, such as provided by Bluetooth or a line-in connection (e.g., physical serial connection). Additionally, many output devices now have ability to receive media content over wireless communication mediums such provided under an 802.11 IEEE standard (e.g., 802.11(a), 802.11(b), 802.11(g), 802.11(n), alternatively referred to as “802.11 protocol” or “Wi-Fi”). The use of such wireless communication mediums affords an advantage over point-to-point connections in that a transmitting device can transmit a media stream to multiple devices at one time.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the disclosure are directed to apparatuses and methods for operating a media output device. In one example, a method is provided for operating a media output device. The media output device is connected to a source device using a point-to-point wireless communication medium, to receive a media content stream. The media content stream is converted from a format of the point-to-point wireless communication medium to a format of the second wireless communication medium. The media output device identifies one or more other media output devices which are interconnected over a second wireless communication medium to form, in combination with the media output device, a group of media output devices. An output configuration is implemented for the group of media output devices, where the output configuration specifies one of the media output devices of the group as a leader device. A transmission of the converted media content stream is initiated from the leader device, in the format of the second wireless communication medium, for synchronized playback of the media content stream on the group of media output devices.

In another aspect, a media output device is provided which includes a first wireless communication interface, a second wireless communication interface, and one or more processors. The one or more processors operate to connect with a source device using the first wireless communication interface to receive a media content stream. The one or more processors convert the media content stream from a format of the point-to-point wireless communication medium to a format of the second wireless communication medium. Additionally, the one or more processors identify media output devices which are interconnected over the second wireless communication medium to form, in combination with the media output device, a group of media output devices. The one or more processors implement an output configuration for the group of media output devices, where the output configuration specifies one of the media output devices as a leader device. The one or more processors imitate transmission of the converted media content stream from the leader device, in the format of the second wireless communication medium, for synchronized playback of the media content stream on the group of media output devices.

In another aspect, a non-transitory computer-readable medium is provided for operating a media output device. The non-transitory computer-readable medium includes instructions that can be executed by a processor of a media output device, to cause the media output device to perform a set of operations. In one example, the media output device performs an operation of connecting to a source device using a point-to-point wireless communication medium, to receive a media content stream. Additionally, the media output device performs an operation of converting the media content stream from a format of the point-to-point wireless communication medium to a format of the second wireless communication medium. The media output device further performs an operation of identifying one more other media output devices which are interconnected over a second wireless communication medium to form, in combination with the media output device, a group of media output devices. Additionally, the media output device performs an operation of implementing an output configuration for the group of media output devices, where the output configuration specifies one of the media output devices of the group as a leader device. The media output device also performs an operation of initiating transmission of the converted media content stream from the leader device, in the format of the second wireless communication medium, for synchronized playback of the media content stream on the group of media output devices.

In another aspect, a media output device is provided which includes a means for connecting to a source device using a point-to-point wireless communication medium, to receive a media content stream. The media output device also includes a means for converting the media content stream from a format of the point-to-point wireless communication medium to a format of the second wireless communication medium. The media output device further includes a means for identifying one or more other media output devices which are interconnected over a second wireless communication medium to form, in combination with the media output device, a group of media output devices. The media output device also includes a means for implementing an output configuration for the group of media output devices, where the output configuration specifies one of the media output devices of the group as a leader device. The media output device further includes means for initiating transmission of the converted media content stream from the leader device, in the format of the second wireless communication medium, for synchronized playback of the media content stream on the group of media output devices.

### BRIEF DESCRIPTION OF THE DRAWINGS

FIG. 1A illustrates an example of an output configuration for a group of media output devices which are individually configured to provide a synchronized output in response to a media stream transmitted over a point-to-point connection.

FIG. 1B illustrates output configuration for the group of media output devices in which different media output devices are used for operating for each of receiving a media stream and controlling transmission and/or playback of the media stream.

FIG. 1C illustrates an example of a media output device that can operate to implement multiple roles in connection with transmission and playback of a source media which is initially communicated over a point-to-point communication medium, according to one or more embodiments.

FIG. 2A and FIG. 2B illustrate alternative examples of a media output device which also operates as a leader device for a group of media output devices.

FIG. 2C illustrates a sequence diagram for an example of FIG. 2B.

FIG. 3A illustrates a variation to an output configuration for a group of media output devices, where a media output device serves a role of proxy for another media output device that is the leader of the group.

FIG. 3B illustrates a sequence diagram for an example of FIG. 3A.

FIG. 4A illustrates another output configuration for a group of media output devices in which a receiver device and a leader device each host media data originating from a media source device.

FIG. 4B illustrates a sequence diagram for an example of FIG. 4A.

FIG. 5A illustrates an example method for operating a media output device as a receiver device.

FIG. 5B illustrates an example method for determining an output configuration for a group of interconnected media output devices.

FIG. 6 is a block diagram that illustrates a network-enabled media output device upon which aspects described herein can be implemented.

### DETAILED DESCRIPTION

Examples described herein provide for a media output device to transmit and synchronize playback of a media content stream that is received over a point-to-point connection on multiple interconnected devices. As described, examples enable a source device to connect to a media output device of a group using a point-to-point connection, in order to generate a synchronized media output on multiple interconnected media output devices. In some examples, the source device can connect to any one of multiple med output devices of a group using a Bluetooth connection. The media output device that connects with the source device over the Bluetooth connection can implement an output configuration for the group of interconnected media output devices. In examples as described, the media output devices are interconnected over Wi-Fi to generate media content on multiple interconnected devices in a synchronized manner.

Among other benefits, examples as described enable media content stream to be communicated by a source device (e.g., media player) over a point-to-point connection (e.g., such as provided by a Bluetooth protocol, line-in) for simultaneous and synchronized playback on multiple media output devices which are interconnected using a second communication medium (e.g., such as provided by an 802.11 protocol, Ethernet, etc.).

One or more aspects described herein provide that methods, techniques and actions performed by a computing device are performed programmatically, or as a computer-implemented method. Programmatically means through the use of code, or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more aspects described herein may be implemented through the use of instructions that are executable by one or more processors. These instructions may be carried on a computer-readable medium. Machines shown or described with figures below provide examples of processing resources and computer-readable mediums on which instructions for implementing some aspects can be carried and/or executed. In particular, the numerous machines shown in some examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, aspects may be implemented in the form of computer programs.

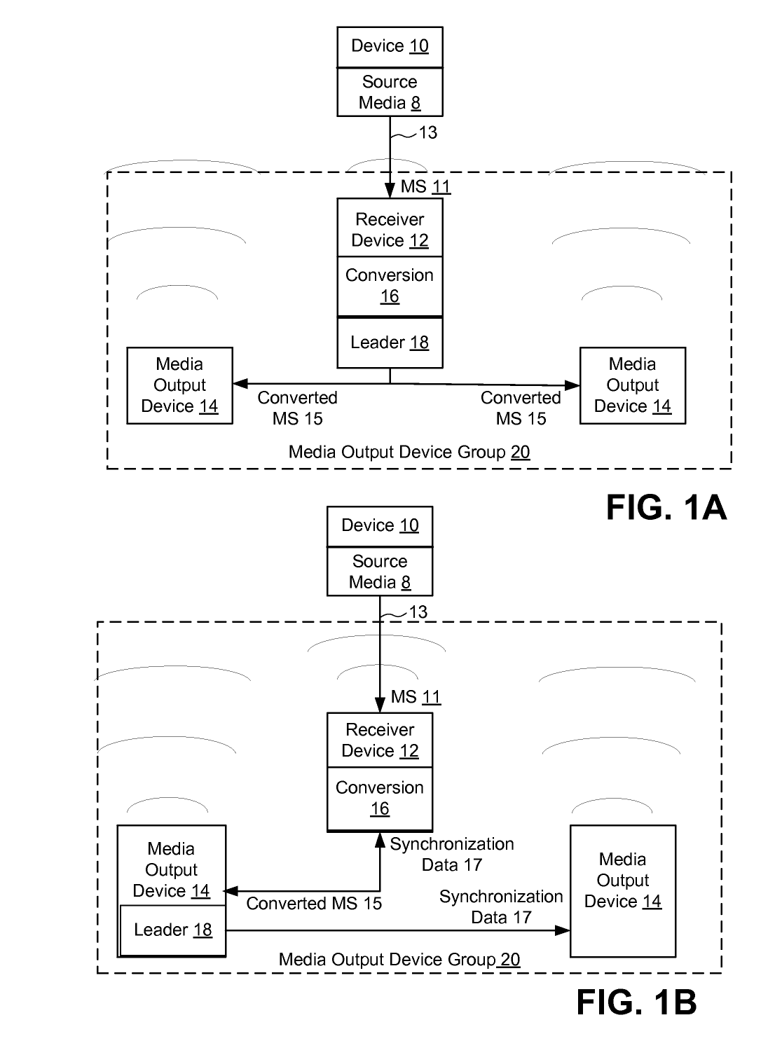

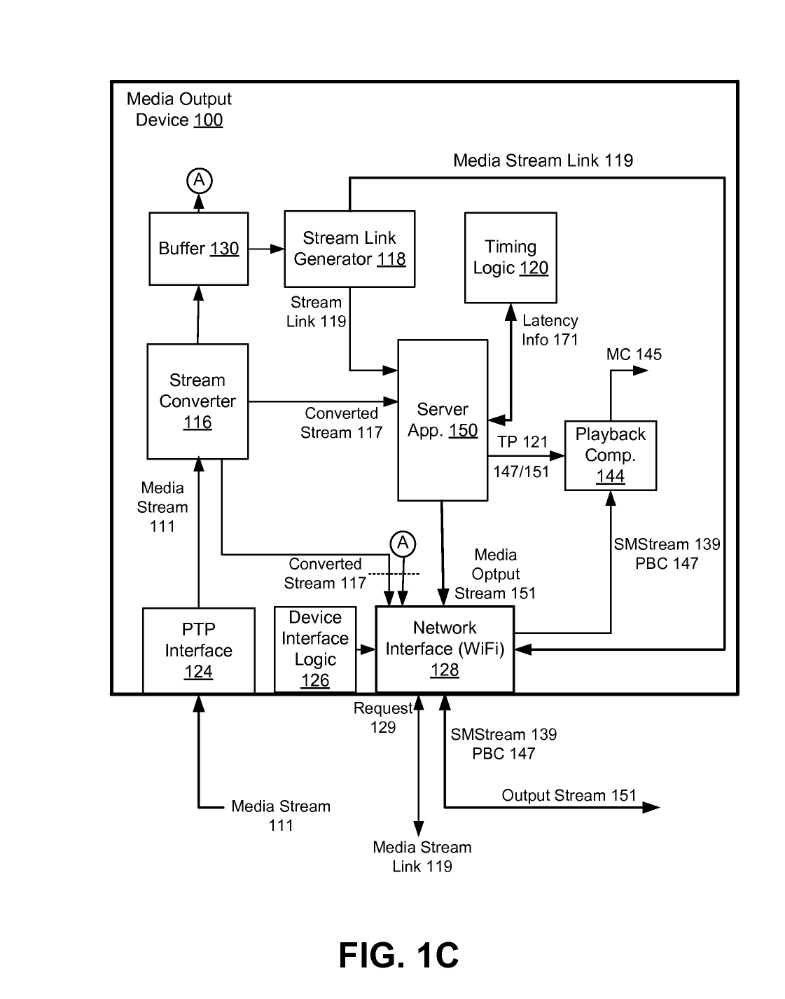

FIG. 1A illustrates an example of an output configuration for a group of media output devices which are individually configured to provide a synchronized output in response to a media stream transmitted over a point-to-point connection. In an example of FIG. 1A, a group of media output devices 20 includes a media output device 12 that operates to receive a source media stream (alternatively referred to as “receiver device 12”) and two or more media output devices 14. More or fewer media output devices can be used in alternative setups and configurations. Collectively, the group of media output devices 20 can be arranged in a physical environment such as a room or dwelling. The group of media output devices 20 can be implemented using a variety of different types of output devices, such as, for example, network enabled speakers or paired speaker sets, as well as multipurpose devices such as network enabled televisions, home media centers, or portable computing devices (e.g., tablets).

In an example shown, a source device 10 provides source media 8 from which media playback is provided. The source media 8 can correspond to, for example, a music file, a music stream that originates from a network service or from a broadcast, or an audio/video file or stream. As an illustrative example, the source device 10 can be implemented by the user operating a mobile computing device (e.g., multifunction cellular telephony/message device, tablet, media player etc.) walking in a dwelling (e.g. living room) and selecting a music file for playback on a combination of devices which can include a network enabled television, speaker set or home computing device. The initial connection between the source device 10 and the receiver device 12 may be through a point-to-point wireless connection, such as provided under a Bluetooth protocol (e.g., Bluetooth 3.0 or 4.0). Upon the initial connection being made with the receiver device 12, media content from the source media 8 can be transmitted to the group of media output devices of the users dwelling in a synchronized manner.

In an example of FIG. 1A, receiver device 12 includes a conversion component 16 and a leader component 18. The receiver device 12 receives the media stream 11, corresponding to the source media 8, over a point-to-point connection 13. The conversion component 16 implements one or more processes to convert the media stream 11 for transmission on an alternative communication medium used to interconnect the receiver device 12 and the media output devices 14. The conversion processes of the conversion component can include, for example, format and sampling rate conversion. As an example, the conversion component 16 receives the media stream 11 in a format of a point-to-point protocol, and then converts the media stream 11 into a format for transmission using an alternative communication medium, such as provided under one of the 802.11 standards (e.g., 802.11(a), (b), (g), (n), etc.), or through a physical connection medium (e.g., Ethernet). Additionally, the conversion component 16 can convert the sampling rate of the media stream 11 to one that is in use with media output devices 12, 14, communicating over the alternative communication medium. Additionally, in some examples, the leader component 18 is implemented as an application or program (e.g., server application 150, see FIG. 1C) and provides functionality for (i) transmitting a converted media stream 15 over the alternative wireless communication medium to the media output devices 14, and (ii) implementing synchronization operations for creating synchronized playback of the converted media stream 15 by the media output devices 14. In one implementation, the leader component 18 perform synchronization operations to synchronize transmission of the converted media stream 15 to the respective media output devices 14. As an addition or variation, the leader component 18 maintains a synchronization clock for enabling each of the media output devices 14 to synchronize for purpose of generating synchronized playback from the converted media stream 15. Still further, the leader component 18 can include buffer control logic to monitor the media buffers of the respective media output devices 14, to detect instances when any of the media buffers are depleted, resulting in sputtering or other unwanted media output characteristics. Still further, the leader component 18 can also include functionality for generating media output that is synchronized for arrival to a desired location, such as to the center of the dwelling or to an estimated location of the source device 10. For example, the leader component 18 can include functionality for approximating a distance of the receiver device 12, and then manipulating audio frames transmitted to one or the other of the media output devices 14 so as to generate a delay on one of the media output devices 14 (e.g., the media output device that is the furthest away from the location where the audio experience is to be synchronized). The delay can be selected so that the audio frame from the delayed media output device is more likely to be perceived as arriving at the same time as the audio from the other media output device.

According to examples described, each of the media output devices 12, 14 can function in different roles, including as a receiver or a leader. A configuration of the group of media output devices 20 can include a determination and designation of specific media output devices 12, 14 in the group which have roles of receiver and leader. In one implementation, when the receiver device 12 makes the initial point-to-point connection 13, a determination is made as to the configuration that the group of media output devices 20 are to have, either for a duration while the connection is sustained, or for a given interval of time following when the connection is first made. For example, in one implementation, once the configuration for the group of media output devices 20 is made with the receiver device 12 making the initial point-to-point connection 13 over the point-to-point wireless communication medium, the configuration can be maintained for the duration during which the source device 10 and the receiver device 12 maintain the connection. In variations, the configuration for the group of media output devices 20 can be dynamic, and changed based on a variety of factors, such as a change to the constituency of the group of media output devices 20 (e.g., new media output device introduced), variations in bandwidth of one or more of the media output devices, and/or change to the source media 8 (e.g., transmission size or quality).

According to some examples, the receiver device 12 can make at least an initial determination of the configuration for the group of media output devices 20. The determination of the configuration can include determining which of the media output devices 12, 14 is to serve as the leader of the group for purpose of playing back media content of the source media 8.

In the configuration shown by FIG. 1A, the receiver device 12 receives incoming media stream 11 from the source device 10 over the point-to-point connection 13. The receiver device 12 can implement a configuration for the group of media output devices 20, in which the receiver device 12 also acts as the leader. The conversion component 16 converts the incoming media stream 11 into a format suitable for transmission over an alternative wireless communication (e.g., Wi-Fi). The leader component 18 can implement operations to (i) synchronize transmission of the converted media stream 15 to each of the other media output devices 14, (ii) synchronize receipt of the converted media stream 15 by each of the media output devices 14, and/or (iii) synchronize arrival of media output for a given location in the dwelling.

Additionally, the receiver device 12 can generate media output that is synchronized with the output from the media output devices 14. In one implementation, the receiver device 12 includes a speaker or other output component, and synchronizes its own output with those of the media output devices 14.

FIG. 1B illustrates output configuration for the group of media output devices in which different media output devices are used for operating for each of receiving a media stream and controlling transmission and/or playback of the media stream. In an example of FIG. 1B, the media output devices 12, 14 implement an alternative configuration when the source device 10 connects to the receiver device 12. The determination to implement the alternative configuration can be made on the receiver device 12, through another device of the group, or still on another device (e.g., source device 10) which may share a communication platform with the media output devices 12, 14. In such a configuration, the receiver device 12 receives the media stream 11, uses the conversion component 16 to convert the media stream 11 into a format for the alternative wireless communication protocol, then transmits the converted media stream 15 to the selected media output device 14. The conversion component 16 can also convert the sample rate of the media stream 11 into a sample rate that is suitable for transmission to the other media output devices over the wireless communication medium. Alternative processes can be used to transmit the converted media stream 15 to the media output device 14 that acts as a leader 18. For example, in one implementation, the receiver device 12 provides the selected media output device 14 with a link (e.g., uniform resource locator (URL)) to access the converted media stream 15 from a buffer of the receiver device 12.

In one implementation, the receiver device 12 is the initial leader, until a determination is made as to which of the media output devices 12, 14 is best suited to be the leader 18 for a given source file or session. Once a decision is made to select another media output device 14 as the leader 18, the receiver device 12 switches roles with the selected media output device 14. As described in greater detail, the switch of leader roles can be accomplished by initiating a media server application on the selected media output device 14 which is to serve as the leader. As an addition or variation, the receiver device 12 can provide the media output device 14 with a link (e.g., URL) to use for access to a buffer of the media stream. In some implementations, the buffer contains a media stream in the converted format. In variations, the buffer may contain the media stream in an unconverted format, and the media output device 14 which implements the functionality of the leader component 18 also performs the conversion process. As the leader 18, the media output device 14 can communicate synchronization data 17 to the other media output devices 12 and 14 so that each of the other media output devices outputs media content of the MS 11 in a time synchronized manner.

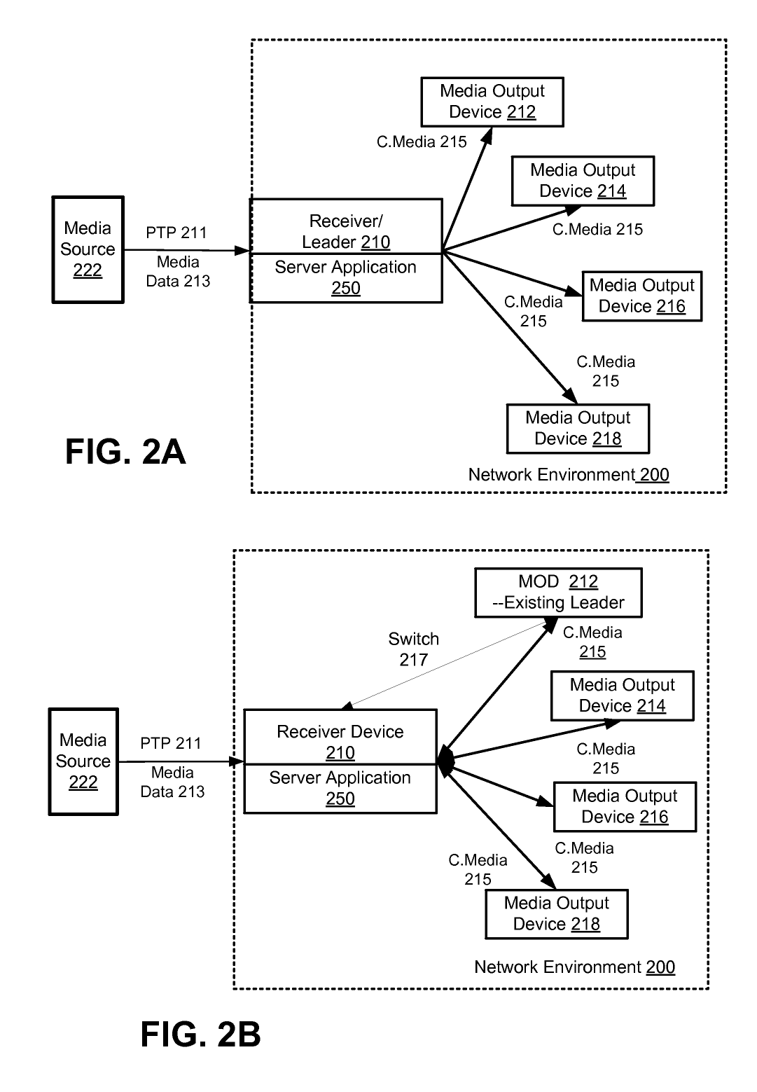

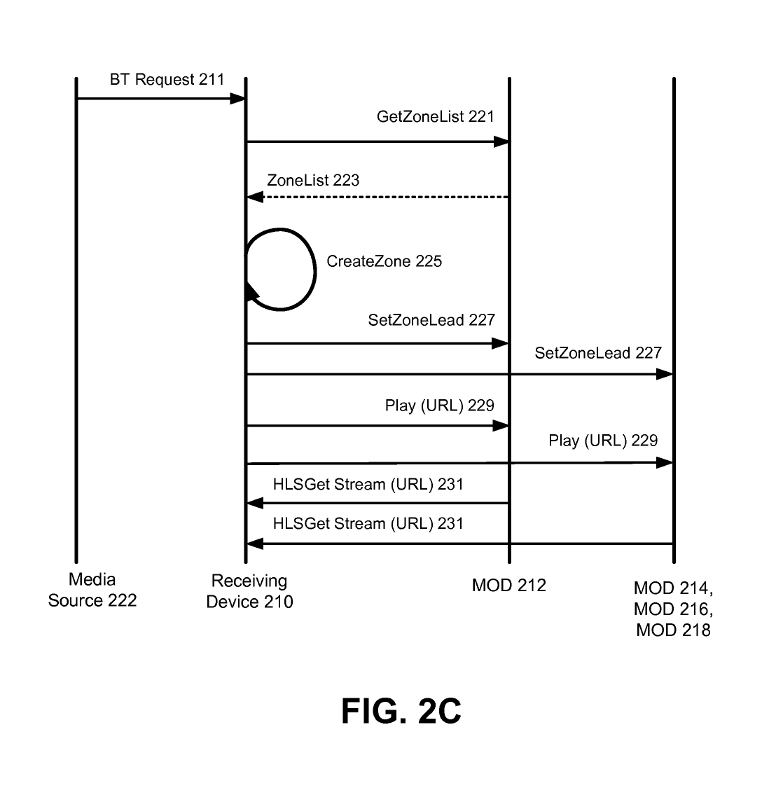

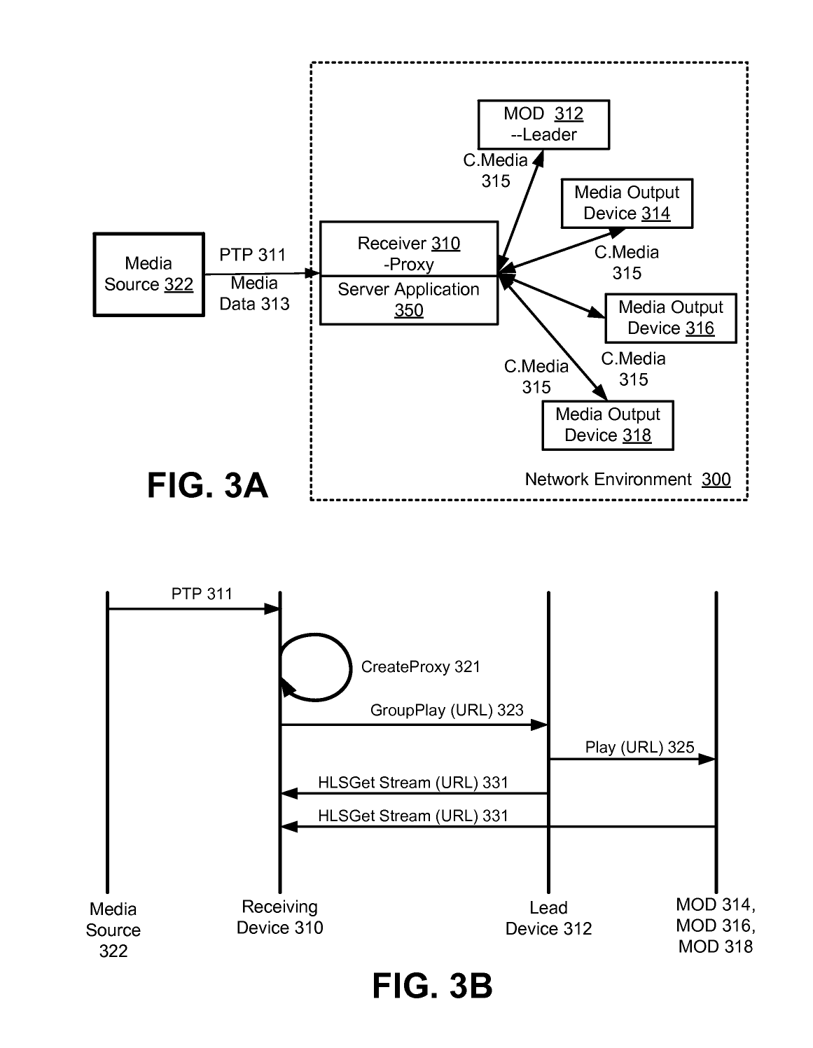

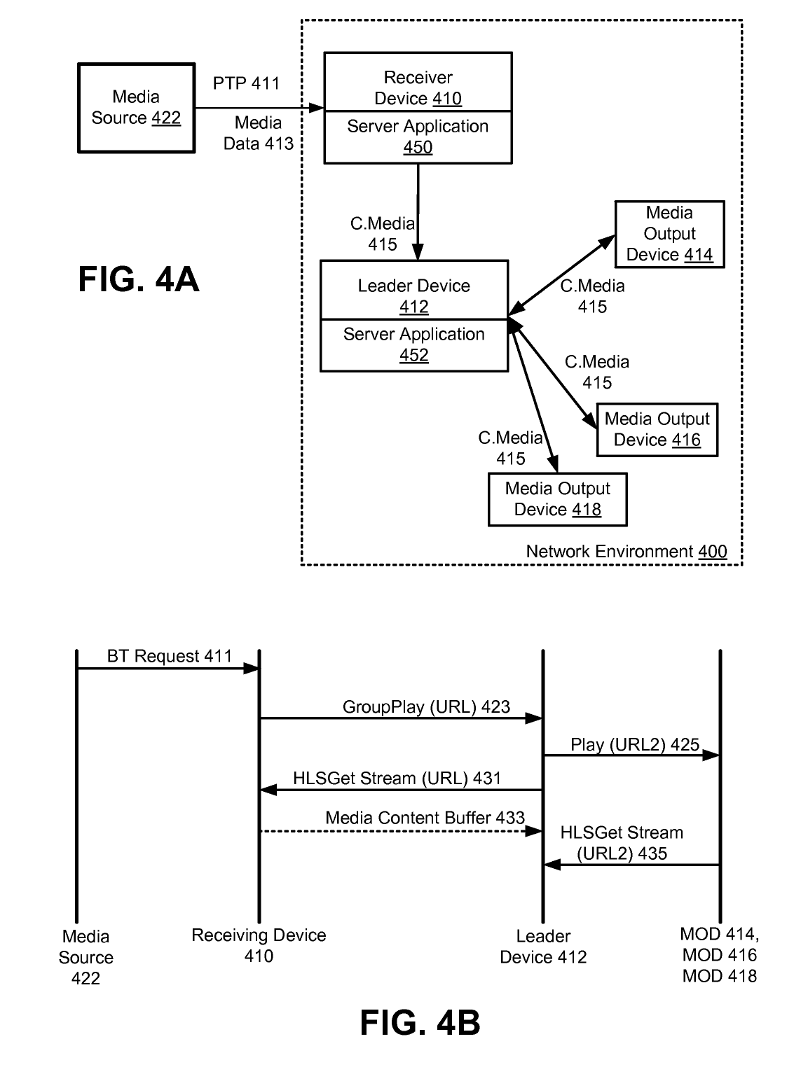

FIG. 1C illustrates an example of a media output device that can operate to implement multiple roles in connection with transmission and playback of a source media which is initially communicated over a point-to-point communication medium, according to one or more embodiments. As shown, a media output device 100 can operate as part of an established group of interconnected network devices, such as described with examples of FIG. 1A-1B, FIG. 2A-2B, FIG. 3A, and FIG. 4A, as well as elsewhere in this application. Accordingly, the media output device 100 can operate to receive a media content stream via a point-to-point wireless communication medium, and to distribute the media content using a second wireless communication medium. According to some examples, the point-to-point wireless communication medium can be implemented under a Bluetooth protocol, and the second wireless communication medium can be implemented under an 802.11 type protocol (e.g., 802.11(a), (b), (g), (n), Wi-Fi-Direct).

While many examples described herein reference media output device 100 as being wireless, variations can also provide for the output device to use wired connections (e.g., Ethernet, serial connection) for either receiving input from a source device, or transmitting output to other interconnected output devices. In an example, media output device 100 corresponds to a network enabled speaker, capable of wireless communications, including Bluetooth and/or Wi-Fi communications. As used herein, a speaker is intended to mean an audio output device, such as a network-connected audio output device. One example of a speaker includes a dedicated device that outputs audio such as music. Another non-limiting example of a speaker includes a multifunctional device, such as a mobile device or tablet, which can output video, capture and store audio content, enable user interaction and/or perform numerous other actions.

According to one aspect, media output device 100 receives media input from a source device using, for example, a Bluetooth connection, and initiates and/or otherwise performs a process by which the input is conveyed to multiple connected devices using a Wi-Fi (or alternative wireless) communication medium. In one implementation, a user can initiate a connection within a dwelling between a source device (e.g., user's mobile computing device) and a given speaker amongst a group of interconnected speakers. According to examples such as described, the user can initiate the connection with one speaker, but have the output transmit to all speakers seamlessly. In this way, examples such as described enable the media output device 100 to initiate, or alternatively perform a process by which media content stream from the media source is seamlessly transmitted to all of the output devices in the group.

With further reference to an example of FIG. 1C, the media output device 100 includes a point-to-point interface 124, a device interface logic 126 and a network interface 128. The media output device 100 also includes a buffer component 130, a server application 150, stream converter 116, stream link generator 118 and timing logic 120. The various components of the media output device 100 can be implemented using programmatic resources and logic, as well as suitable hardware components (e.g., processor, microprocessor, integrated circuits, etc.). While the functionality described with the specific components are described in modular form, the functionality described can be provided in various forms, depending on the type and platform of the media output device 100. Thus, while the components of the media output device 100 is shown as distributed, variations can provide for the components to the implemented on common module or hardware element, such as on a central processor or specific type of network interface.

The network interface 128 includes software and logic for controlling a network port of the media output device 100 (e.g., 802.11 module). Likewise, the point-to-point interface 124 can include logic for controlling a corresponding port for use in point-to-point connections (e.g., Bluetooth module). According to one example, the media output device 100 can include ports and/or resources to enable communications from the device over multiple types of wireless communication mediums, such as over short, mid or long range wireless communication mediums. By way of example, media output device 100 can communicate with other output devices using a wireless local area network, such as provided through any one of the 802.11 protocols. Still further, the media output device 100 can operate to establish one or many wireless peer-to-peer communications, such as provided through an 802.11 protocol (e.g., Wi-Fi Direct). Still further, in some implementations, the network that interconnects the media output devices can correspond to a wired network.

In some variations, the device interface logic 126 includes logic for enabling the media output device 100 to communicate with other network-enabled devices over a network environment (e.g., home network), using selected or available network ports and resources of the media output device 100. The device interface logic 126 can be implemented as an application, hardware component, or logic integrated with other resources, such as the network interface 128. The device interface logic 126 can, for example, use the network interface 128 to trigger or implement processes to advertise the presence, capabilities and availability of the media output device 100, as well as to enable the formation of network connections to other devices interconnected devices. In one implementation, device interface logic 126 includes an application program interface provided through, for example, ALLPLAY, manufactured by QUALCOMM CONNECTED EXPERIENCES, in order to connect two or more output devices in an inter-connected group.

In an example shown by FIG. 1C, a source device (not shown in FIG. 1C) can transmit a media stream 111 to the media output device 100 through the device interface logic 126 or the point-to-point interface 124. The media output device 100 can implement a role of receiver using the stream converter 116, which includes logic for converting the media stream 111 into a format for the protocol of the alternative wireless communication medium (e.g., Wi-Fi). The stream converter 116 can also include logic to convert the sampling rate of the media stream 111 into one that is in use or selected for the media output devices which communicate over the wireless communication medium. In one implementation, stream converter 116 first decodes the media stream 111 using, for example, a Bluetooth codec program. In variations, other codec programs can be used to handle protocol and/or formatting provided with other types of connections, such as wired connections. Some examples of codec programs that can be used in the stream converter 116 include Low Complexity Sub-band Coding or SBC codec, or an Advanced Audio Coding or AAC codec. In one embodiment, the stream converter 116 converts the media stream 111 into a pulse-code modulation (PCM) format, and then implements logic to recode the stream for transmission over the alternative wireless communication medium (e.g., Wi-Fi). Thus, the process to convert the incoming media stream 111 can include decoding, reformatting, and recoding. An example of a recoding process which can be used for transmitting the media stream 111 over Wi-Fi includes Free Lossless Audio Codec (or FLAC).

The stream converter 116 can buffer the converted media stream using the buffer component 130. When the media output device 100 operates as the receiver but not the leader, the converted media stream 117 can be communicated from the buffer component 130 to the network interface 128. In alternative implementations, the stream converter 116 can transmit the converted media stream 117 directly to the network interface 128.

In some implementations, the stream link generator 118 generates a media stream link 119 that locates the converted media stream 117 in the buffer component 130. The media stream link 119 can be structured using, for example, device interface logic 126, so that the link (and a corresponding request which can be generated from the link) is recognizable to other media output devices that share a common communication platform with the media output device 100. The stream link generator 118 can forward the stream link 119 to other output devices on the network, thus notifying receiving devices of the location from where to fetch the synchronized media output stream 151.

When the media output device 100 operates as leader, the server application 150 can be initiated. The server application 150 can obtain the converted media stream 117 directly from the stream converter 116 or from the buffer component 130. The server application 150 can implement operations on the converted media stream 117 in order to generate the synchronized media output stream 151 to synchronize the output of the media content on multiple media output devices. The synchronized media output stream 151 can be transmitted to other media output devices using the network interface 128.

In one implementation, the server application 150 acquires information from one or more sources in order to determine latency or timing parameters 121. Based on the communication with the other output devices on the network, the media output device can augment or manipulate the output stream received by the other output devices when acting as a leader. As the leader, the media output device can collect information about the other output devices through the device interface logic 126 and/or network interface 128. An example of information the leader device can collect includes an updated list of output devices, unique identifiers for each device, network bandwidth information and transmission delay or latency information associated with each device. In one example, the media output device can collect latency information 171 by pinging the other devices connected on the network. In other examples, the server application 150 can test latency through the network interface 128, or measure latency from other resources that may be resident on the media output device 100. The server application 150 can also obtain information that identifies the type of source media.

In some variations, the device interface logic 126 can maintain a repository or other data structure which monitors for the status of other known media output devices in the dwelling. The device interface logic 126 may also obtain information about the capability (e.g., such as whether the other device has a digital signal processor (DSP)), and available bandwidth of the individual devices. The server application 150 can access information maintained in the repository of the device interface logic 126 in order to determine timing parameters 121 (“TP 121”).

Still further, in other variations, the timing logic 120 can collect the latency information 171 from the device interface logic 126 and detect the slowest output device on the network based on the transmission delay associated with each of the output devices on the network. The timing logic 120 can generate the timing parameters 121 based on the latency information 171 of the slowest output device on the network. In some aspects, the timing parameters 121 can also be based on the available network bandwidth associated with each of the output devices on the network. The timing logic 120 can forward the timing parameters 121 to the server application 150 for further processing.

Still further, the server application 150 can utilize stored settings, including default settings or user preferences, in order to determine timing parameters 121. The server application 150 can utilize timing parameters to generate a synchronized media output stream 151 from the converted media stream 117. The synchronized media output stream 151 can be communicated to the other media output devices using the network interface 128.

In an implementation in which the media output device 100 is not the leader, variations provide that the media stream link 119 can be communicated via the network interface 128 to the media output device that is operating as the leader. The device interface logic 126 and network interface 128 can combine to receive and handle a request 129 generated from the device that received the media stream link 119. The request 129 can locate a buffer portion for the buffer component 130 where converted media stream 117 is temporarily stored. The device interface logic 126 and network interface 128 can then combine to respond to the request by accessing the buffer and transmitting the buffered data over the alternative communication medium (e.g., Wi-Fi). Subsequently, the wireless output device can receive a synchronized media stream 139 from another media output device that is operating as the leader. The synchronized media stream 139 can be processed by a playback component 144, to generate media content 145 (“MC 145”) that is synchronized under the control of the media output device operating as the leader.

In some examples, the media output device 100 is representative of functionality which is present with some or all of the other media output devices in a given environment (e.g., dwelling). Accordingly, each of the media output devices in a group may be interconnected, and further configured with programmatic resources such as described with an example of FIG. 1C. As a group, the media output devices can utilize a functional hierarchy. Furthermore, decision logic can be implemented to determine a configuration of the group, including a designation or selection of a leader device and/or other functional hierarchy.

The configuration of the group of media output devices can be determined based on capabilities of individual devices, network bandwidth at particular locations, bandwidth of individual devices, and/or other factors. Thus, for example, media output device 100 (as well as other devices of the group) can include logic to enable the device to operate in the roles of either leader or receiver, similar to a master/slave configuration. As a leader, any of the media output devices in the group can host the server application 150, which can reside as an application or other form of logic. Additionally, in some variations, the media output device that is designated as the leader can perform operations to control, for example, (i) timing values by which devices synchronize output (e.g., as provided by timing logic 120), (ii) playback control commands 147, where the media output devices are commanded to play, pause, stop, select a particular track, or perform another operation in unison, and/or (iii) implement buffer control logic, in which the amount of buffered data on each media output device can be monitored to avoid sputtering or loss of data on any particular device. Conversely, any of the media output devices in a group can receive and implement playback control commands 147 (“PBC 147”) for playback control and/or buffer control, as provided from the media device that operates as the leader. Moreover, the roles (e.g., leader) which are assigned to the media output devices as a group can be selected and reselected over time based on criteria as described above.

In FIG. 1C, the media output device 100 is described with respect to possible roles of receiver or leader. In variations such as shown with FIG. 4A and FIG. 4B, the media output device 100 can also have a role of proxy. Thus, the output configuration for a group of media output devices can result in any one of many possible roles being conferred on a given media output device 100.

In variations, alternative connection configurations can be employed amongst a group of interconnected output devices for purpose of receiving and handling media content from a media source device which makes a point-to-point connection to one media output device in a group of interconnected media output devices. In some examples, a group of interconnected media output devices can establish interconnectivity with one another over a given network communication medium (e.g. Wi-Fi) using a functional hierarchy, where one device acts as a leader for delivering media content from a source device to the other devices. In such configurations, the particular output device that has the role of leader can host, for the other output devices of the group, a server application with accompanying media data from a media source. The receiver devices in the group can generate client-type requests for media data from the device that acts as the leader. Furthermore, in some implementations, each of the devices in the group can maintain a buffer of media data for playback. Still further, each of the devices in the group can synchronize playback with one another using a centralized or reference clock (e.g., the clock of the leader device, the clock of the access point, etc.). Accordingly, the leader device can implement functionality to control buffer size on the respective devices, to monitor for buffer data shortage, and/or to communicate a reference clock signal for all the other devices to use when synchronizing their media output.

In some examples, the functional hierarchy is transparent to the user, so that the user is not aware of the respective role of any one particular device. Rather, the user may introduce a media source device to the group of media output devices by first connecting to a media output receiver via a point-to-point connection. The respective roles of the group of media output devices can change based on, for example, a position of the user, or resources available to any one media output device. Thus, media output devices in the group can be selected for roles of receiver device and leader device. By way of example, the user can bring a mobile computing device (as a source of a media content stream) in close proximity to a particular speaker in a group of speaker devices. The proximity of the user to one media output device in the group may designate the particular device as a media output receiver. Additionally, as described with other examples, at least one of the media output devices can select another of the media output devices to be the leader. Under examples described, the user may have no awareness of the roles that individual media output devices have with respect to a connected source device. Rather, the user experiences output of a corresponding media content on multiple media output devices in synchronous fashion.

FIG. 2A and FIG. 2B illustrate alternative examples of a media output device which also operates as a leader device for a group of media output devices. With reference to examples of FIG. 2A and FIG. 2B, one or more of the media output devices 210, 212, 214, 216 and 218 can be configured or structured in accordance with functionality and resources such as described with an example of FIG. 1C.

In an example of FIG. 2A, media source device 222 initiates a point-to-point connection 211 with a media output device 210 (alternatively referred to as the “receiver device 210” or “receiver/leader 210”) that is initially a leader of a group of media output devices 210, 212, 214, 216, and 218. FIG. 2B illustrates an alternative example in which a media source device 222 initiates a point-to-point connection 211 with a receiver device 210 that initially is not the leader, but becomes the leader of the group of output devices 210, 212, 214, 216 and 218 in order to transmit media data from the media source device to the other output devices.

With reference to FIG. 2A and FIG. 2B, the media output devices 210, 212, 214, 216 and 218 are interconnected using, for example, a communication medium implemented under the 802.11 protocols. Still further, some or all of the media output devices 210, 212, 214, 216 and 218 can communicate directly with other devices on the network as peers. By way of example, the individual output devices 210, 212, 214, 216, and 218 can communicate using a direct, wireless peer-to-peer communication protocol, such as provided by Wi-Fi Direct.

The output devices 210, 212, 214, 216 and 218 can be connected and physically located within the network environment, based on preference of a user. The network environment 200 can correspond to a dwelling, a room or space which shares a local wireless communication medium (e.g., Wi-Fi hot spot). By way of example, network environment 200 can correspond to a home network in which multiple speakers or other audio output devices are provided with network connectivity for purpose of outputting audio content selected by the user. In this context, the user may selectively position individual connected speakers about a room to enhance the user's enjoyment of rendered audio content. The user can also select any media output device 210, 212, 214, 216 or 218 for the initial connection with a media source device, using a point-to-point connection (e.g., Bluetooth). The selection of the media output device 210, 212, 214, 216 or 218 for the initial connection can alternatively be done automatically, based on user setting and/or user proximity to a particular device (e.g., media output device 210 can be most proximate to the media source device 222).

In an embodiment, the media output devices 210, 212, 214, 216 and 218 can be heterogeneous in nature, meaning that the devices can have different manufacturers, capabilities, resources and/or purposes. For example, in one implementation, one or more of the output devices can correspond to a television, for which audio output is not a primary purpose. In one implementation, each of the media output devices 210, 212, 214, 216 and 218 includes programming or other logic to enable that device to communicate with other devices on the network. More specifically, each of the output devices can execute a common application platform that enables, among other functionality, interoperability amongst heterogeneous devices, communications amongst such devices over to the network environments, advertisement discovery by connecting devices, as well as the ability of individual devices to announced her capabilities to other interconnected devices of the network. An example of such programming or logic includes ALLPLAY platform, manufactured by QUALCOMM CONNECTED EXPERIENCES, which can be installed or otherwise provided through firmware on wireless speakers. The media output devices 210, 212, 214, 216 and 218 can include speakers or audio output devices. In variations, the media output devices 210, 212, 214, 216 and 218 can output video. The output devices described can include both dedicated a purposeful devices (e.g., network connected speakers). In variations, some or all of the devices in the group can be multipurpose devices, or alternatively, output media of a particular kind as a secondary function.

With further reference to examples of FIG. 2A and FIG. 2B, the media source device 222 is shown to connect to the receiver device 210 using a point-to-point connection 211. The network environment 200 can include multiple connected devices having an established interconnection and functional hierarchy. The functional hierarchy can specify a leader to be one of the media output devices 210, 212, 214, 216 or 218. By way of example, the point-to-point connection 211 can correspond to a Bluetooth connection, or alternatively, to a line-in connection. The media output device 210, 212, 214, 216 or 218 that is selected to be the leader may correspond to the media output device which satisfies a criteria that defines a minimum set of required resources for operating as a leader, such as a minimum processing capability and/or an ability to establish multiple simultaneous peer-to-peer connections with other devices. Alternatively, the media output device 210, 212, 214, 216 or 218 that is selected to be the leader can be the device that has the best or most abundance of a desired resource or capability. For example, the receiver device 210 can be selected as the leader device because it includes a digital signal processor (“DSP”), or because the receiver device 210 is deemed to have the greatest amount of available bandwidth. As described with other examples, the selection of one media output device as the leader can be made programmatically, using for example, dynamic selection logic.

With specific reference to an example of FIG. 2A, the media source device 222 communicates media data 213 to the receiver/leader 210. The format and structure of the media data 213 can be dictated by the point-to-point connection 211. The receiver/leader 210 operates to retransmit a converted form of the media data 213 (“converted media stream 215”) to the other interconnected media output devices 212, 214, 216 and 218 of the group. The receiver/leader 210 can include functionality such as described with an example if FIGS. 1A-1C in order to perform the conversion.

While some examples described utilize intelligence and flexibility as to the selection of a leader, an example of FIG. 2A can be implemented in a static configuration, where receiver/leader device 210 is the only device of the group that can transmit media data to other devices. For example, the media source device 222 can be precluded from connecting to any other media output device 212, 214, 216 or 218 other than the receiver/leader 210, and visual or other types of markings may be provided with the receiver/leader 210 to denote its status. Alternatively, the network environment 200 can be dynamically configurable, so that different media output devices 210, 212, 214, 216 and 218 can fulfill the leader role. In such an implementation, the media source device 222 can connect to the receiver/leader 210 based on setting, preferences, proximity or other consideration.

FIG. 2B illustrates an alternative output configuration for the group of media output devices. In an example of FIG. 2B, the receiver device 210 for a point-to-point connection becomes the leader of the group of output devices in response to the media source device 222 initiating the point-to-point connection 211. Thus, in an example of FIG. 2B, the media source device 222 connects to the receiver device 210 at a time when the receiver device 210 does not have the role of leader in the group of media output devices 210, 212, 214, 216 and 218. In an example of FIG. 2B, the receiver device 210 is made the leader in order to transmit the converted media stream 215 to the other media output devices.

With further reference to an example of FIG. 2B, media output device 212 is shown to be selected as the leader when media source device 222 connects to the receiver device 210. In response to the media source device 222 making the connection to the receiver 210, the receiver device 210 initiates a switch 217. The switch 217 can correspond to a programmatic request from receiver device 210 to become leader as a result of the point-to-point connection 211 being initiated or made. Some or all of the media output devices 210, 212, 214, 216 and 218 can be pre-programmed to be responsive to implement the switch 217 when the media source device 222 initiates or makes the point-to-point connection with a non-leader device of the group. Thus, for example, the receiver device 210 can signal a switch instruction to become the new leader in response to the media source device 222 making the point-to-point connection 211. The switch instruction can be received by another one of the media output devices which has the role of current leader. In response to the switch instruction from the receiver device 210, the media output device that is the current leader can implement the switch 217 to non-leader, so that the receiver device 210 becomes the new leader.

As an example, a user can carry a media output device and approach one of the media output devices 210, 212, 214, 216, 218 using a point-to-point connection 211 or line-in. When the connection to the receiving device 210 is initiated, an example of FIG. 2B provides that the receiver device 210 initiates a process to become the leader device. As the leader, receiver device 210 can host a server application 250 locally, so that other media output devices 212 (shown as the previous leader device), 214, 216 and 218 can access the media source content over a Wi-Fi medium (or other connection medium). Once operating as a leader, the receiver device 210 can also reformat or otherwise convert the media data from the media source device 222 into the converted media stream 215, which has a format (including codec or structure) suitable for transmission over Wi-Fi (or other communication medium). The functionality for converting the media data to Wi-Fi (or other connectivity medium) compatible format can be implemented independent of the role of the device as a leader.

FIG. 2C illustrates a sequence diagram for an example of FIG. 2B. FIG. 2C illustrates examples of communications exchanged between media source device 222, receiver device 210 (which becomes leader), media output device 212 (which relinquishes leader) and the other media output devices 214, 216 and 218 of the network environment 200, in order to dynamically switch the particular media output device that is operating as the leader. In an example of FIG. 2C, the receiver device 210 can receive a Bluetooth request from media source device 222. The receiver device 210 programmatically obtains a list of media output devices operating within the network environment 200 from, for example, the then-existing leader, media output device 212 (GetZoneList 221).

Other variations can also be implemented for determining the media output devices operating on the network environment 200. For example, the zone list can be maintained by each of the media output devices 210, 212, 214, 216 and 218, so that the receiver device 210 does not need to invoke an instruction such as shown by GetZoneList 221.

Once the receiver device 210 receives ZoneList 223 from output device 212, it can establish itself as the new leader device by (i) creating a dynamic list of the media output devices 210, 212, 214, 216 and 218 operating within the network environment (CreateZone 225), and (ii) sending communications to the other media output devices 212, 214, 216 and 218 that identifies the new leader device (SetZoneLead 227). After the receiver device 210 has initiated a server application 250 to access the output stream, the receiver device 210 sends a link or URL (for example, media stream link 119 in FIG. 1C) to the other media output devices 212, 214, 216 and 218. The link can carry or embed information about the location of the output stream (Play 229). The other media output devices 212, 214, 216 and 218 can select the link in order to access the output stream from the server application 250 using a media streaming protocol suitable for Wi-Fi (HLSGet Stream 231).

FIG. 3A illustrates a variation to an output configuration for a group of media output devices, where a media output device serves a role of proxy for another media output device that is the leader of the group. With reference to an example of FIG. 3A, one or more of the media output devices 310, 312, 314, 316 and 318 can be configured or structured in accordance with functionality and resources such as described with an example of FIG. 1C.

In an example of FIG. 3A, a receiver device 310 is connected to media source device 322 using a point-to-point connection 311 (e.g., Bluetooth or line-in) to receive media data 313. As the proxy, the receiver device 310 can reformat or otherwise convert the media data 313 from the media source device 322 into converted media data 315. The converted media data 315 may have a format and structure suitable for communication over Wi-Fi (or other communication medium). The functionality for converting the media data 313 into a format suitable for transmission and use over, for example, a Wi-Fi medium can be implemented independent of the role of the receiver device 310 as leader or proxy.

The receiver device 310 can host a server application 350 locally, so that other devices 314, 316 and 318 and leader device 312 can access the media source content over an alternative communication medium (e.g., Wi-Fi). Furthermore, in an example of FIG. 3A, the receiver device 310 can establish itself as a “proxy” for the leader device to host the media content on its server application 350, so that other devices are instructed to get the output stream directly from receiver device 310.

FIG. 3B illustrates a sequence diagram for an example of FIG. 3A. More specifically, FIG. 3B illustrates a sequence of communications between media source device 322, receiver device 310, leader device 312 and other media output devices 314, 316 and 318 of the group in the network environment 300. In an example of FIG. 3A and FIG. 3B, a user may form an initial connection with the receiver device 310 through proximity. In response, the receiver device 310 receives a Bluetooth connection request. The receiver device 310 can establish itself as a proxy for the leader device (“CreateProxy 321”) and send a group play URL 323 or link to the leader device 312 (“GroupPlay URL 323”). The group play URL 323 or link can be associated with the location of the output stream on server application 350 of receiver device 310 (see e.g., media stream link 119 of an example of FIG. 1C). The leader device 312 can forward the link (Play 325) to the other media output devices 314, 316 and 318 in the network environment 300, and the link can also specify a location on, for example, the receiving device 310 or the leader device 312, where the converted media stream can be retrieved. The other media output devices 314, 316 and 318, as well as the leader device 312, can each use the link to access the output stream from the server application 350 using a media streaming protocol over Wi-Fi (HLSGet Stream 331).

FIG. 4A illustrates another output configuration for a group of media output devices in which a receiver device and a leader device each host media data originating from a media source device. With reference to an example of FIG. 4A, one or more of the media output devices 410, 412, 414, 416 and 418 can be configured in accordance with functionality and resources such as described with an example of FIG. 1C

In more detail, one of the media output devices 410 (also referred to as “receiver 410”), 412, 414, 416 or 418 is connected to media source 422 using a point-to-point connection 411 (e.g., Bluetooth or line-in) to receive media data 413. As the proxy, the receiver device 410 can reformat or otherwise convert the media data 413 from the media source 422 into converted media data 415. In the converted state, the media data 415 has format and structure required for transmission over Wi-Fi. The functionality for converting the media data to a format suitable for Wi-Fi can be implemented independent of the role of the device as leader or proxy. Once the media source 422 is connected, the receiver device 410 and another media output device 412 acting as the leader (also referred to as “leader device 412”) can each initiate a corresponding server application 450, 452 to host the output stream for access by the other media output devices 414, 416 and 418 in the network environment 400.

In an example of FIG. 4A, receiver device 410 can be connected to the media source using a point-to-point connection, such as provided by Bluetooth or line-in connection. The receiver device 410 can reformat or otherwise convert the media data 413 from the media source 422 into converted media data 415, which has a format and structure suitable for communication over Wi-Fi (or other communication medium). The functionality for converting the media data to a Wi-Fi (or other connectivity medium) compatible format can be implemented independent of the role of the device as leader or proxy. The receiver device 410 can host a server application 450 locally, giving access for the media content stream only to the leader device 412 over another communication medium (e.g., Wi-Fi). The leader device can then host another local server application 450, so that other media output devices 414, 416 and 418 in network environment 400 can access the buffered media content stream from the leader device 412. Buffering logic can be implemented amongst the devices so that at the time of playback, each of the media output devices 410, 412, 414, 416 and 418 outputs media at the same time.

FIG. 4B illustrates a sequence diagram for an example of FIG. 4A. In more detail, an example of FIG. 4B illustrates a sequence of communications between media source 422, receiver device 410, leader device 412 and the other media output devices 414, 416 and 418 in the network environment 400. The receiver device 410 can receive a Bluetooth connection request from media source 422. Once the receiver device 410 provides a server application 450 to host the output stream, it can send a group play URL or link to the leader device 412 (“GroupPlay (URL) 423”). The link (e.g., see media stream link 119 in FIG. 10) may be associated with the location of the output stream on server application 450 of the receiver device 410. The leader device 412 can then also provide the server application 450 locally on the leader device 412 to host the output stream for the other media output devices 414, 416 and 418. The leader device 412 can send a different URL to the other media output devices 414, 416 and 418 (“Play (URL) 425”), specifically one that is linked to a location of the output stream as provided by the server application 450 of the leader device 412. The leader device 412 can then (i) access the output stream from the server application 450 on the receiver device 410 (“HLSGet Stream (URL) 431”), (ii) buffer the output stream in a buffer on the leader device 412 (“Media Content Buffer 433”) and (iii) provide access to the buffered output stream from the locally hosted server application 450 (“HLSGet Stream (URL) 435”) to the other media output devices 414, 416 and 418.

Among other benefits, examples such as described enable a user to stream audio or video content from a media source device to multiple output devices, using an initial point-to-point connection. The output of the output devices can be synchronized, so that the media content of the media source is output on multiple devices at one time. For example, a user can connect a mobile device to any speaker in a home network via Bluetooth and stream the content from the mobile device to all the speakers on the home network at once. Alternatively, the user can also choose to stream a video from his or her mobile device to multiple video screens on the home network. Alternative combinations of video and audio may also be streamed to different devices using the method disclosed, so that the output generated by the audio and video device is synchronized. For example, a user may choose to stream the video on a television screen while also streaming the synchronized associated audio on an external speaker.

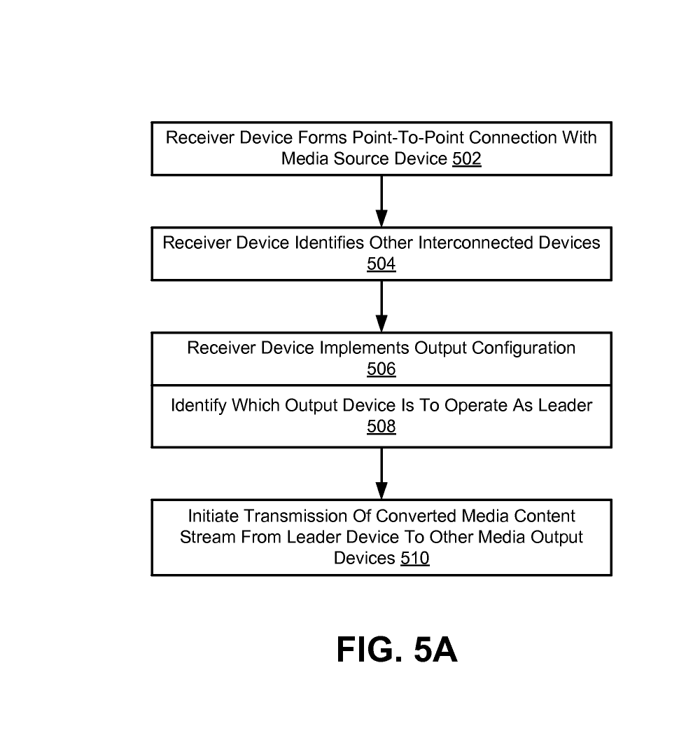

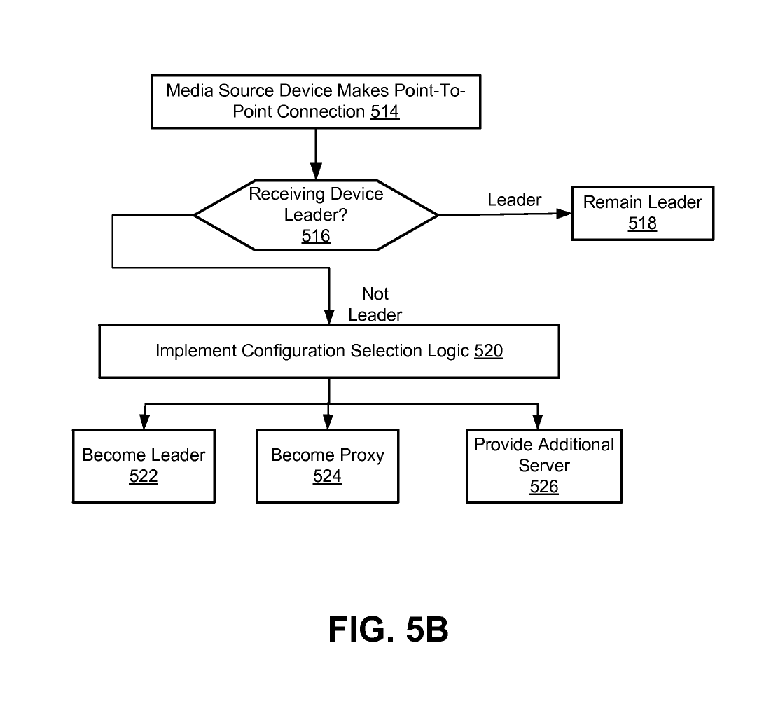

FIG. 5A illustrates an example method for operating a media output device as a receiver device. In describing an example method of FIG. 5A, reference is made to elements of FIG. 1A and FIG. 1B for purpose of illustrating a suitable component or element for performing a function of a step or sub-step of the example.

With reference to FIG. 5A, a receiver device can be used in forming a point-to-point connection with the media source device (502). For example, the point-to-point connection can be a Bluetooth connection, or alternatively, a physical connection (e.g., line-in). The receiver device 12 can implement a conversion process (e.g., shown by conversion component 16) to convert the media data received over the point-to-point connection to a format suitable for transmission over an alternative wireless communication medium, such as one suitable for Wi-Fi.

The receiver device 12 may have established interconnectivity with one or more media output devices 14 using an alternative wireless communication medium. Upon the point-to-point connection being made with the source device 10, the receiver device 12 can identify the interconnected media output devices 14 (504). The receiver device 12 and media output devices 14 collectively form a group of media output devices.

When the connection is formed with the source device 10, the receiver device implements an output configuration for the group of media output devices 12, 14 (506). The output configuration can identify which of the group of media output devices is to operate as the leader (508).

The receiver device 12 can initiate transmission of the converted media content stream from the leader device to the other media output devices 14 (510). If the receiver device 12 is the leader device, the receiver device 12 can initiate a server application or process to, for example, transmit the converted media stream 15 to the other media output devices 14 of the group. If one of the media output devices 14 is the leader, then the receiver device 12 can perform a process to enable the leader device to acquire the media stream. As described with an example of FIG. 1C, for example, the receiver device 12 can buffer the converted media stream 15 and provide a link to enable a server application of the leader device to access the buffered media stream.

FIG. 5B illustrates an example method for determining an output configuration for a group of interconnected media output devices. For further illustration, in describing an example method of FIG. 5B, reference is made to elements of FIG. 2A and FIG. 2B for purpose of illustrating a suitable component or element for performing a function of a step or sub-step of the example

With reference to FIG. 5B, the receiver device 210 makes a point-to-point connection with the media source device 222 (514). The point-to-point connection can be formed as a Bluetooth connection, or via a line-in connection. Once the connection is made, a conversion process is performed on the receiver device 210 in order to convert the media data received into an alternative format, such as one suitable for Wi-Fi.

When the connection is initiated or formed, a determination is made as to whether the receiver device 210 is a leader of an interconnected group of media output devices 210, 212, 214, 216 and 218 (516). If the receiver device 210 is the leader, one aspect provides that the receiver device 210 remains as the leader while receiving media content data from the media source device 222 (518).

If the receiver device 210 is not the leader at the time when the point-to-point connection is formed, configuration selection logic may be executed in order to determine a desired output configuration amongst the group of media output devices 210, 212, 214, 216 and 218 (520). The configuration logic can be implemented to weigh or otherwise consider variety of parameters and factors in determining the output configuration for the group of media output devices 210, 212, 214, 216 and 218, as well as which of the media output devices are to serve the role of leader.

In one implementation, the receiver device 210 can respond to the point-to-point connection by initiating communications with the leader device and further implementing steps to become the leader of the group of output devices (522). By becoming the leader, the receiver device 210 can implement a server application 250 that enables other devices that access the media data provided from the media source device 222.

As an alternative, the receiving device can respond to the point-to-point connection by implementing a process to become a proxy for the lead device (524). As the proxy, the receiver device 210 can also execute the server application 250 to host the media data (e.g., converted media data) that is to be communicated to the other media output devices 212-218. An example of such an output configuration is described in greater detail with examples of FIG. 3A and FIG. 3B.

As another alternative or variation, the receiver device 210 can implement the server application 250 in connection with a different leader executing a corresponding server application (526). An example of this output configuration is further described with examples of FIG. 4A and FIG. 4B.

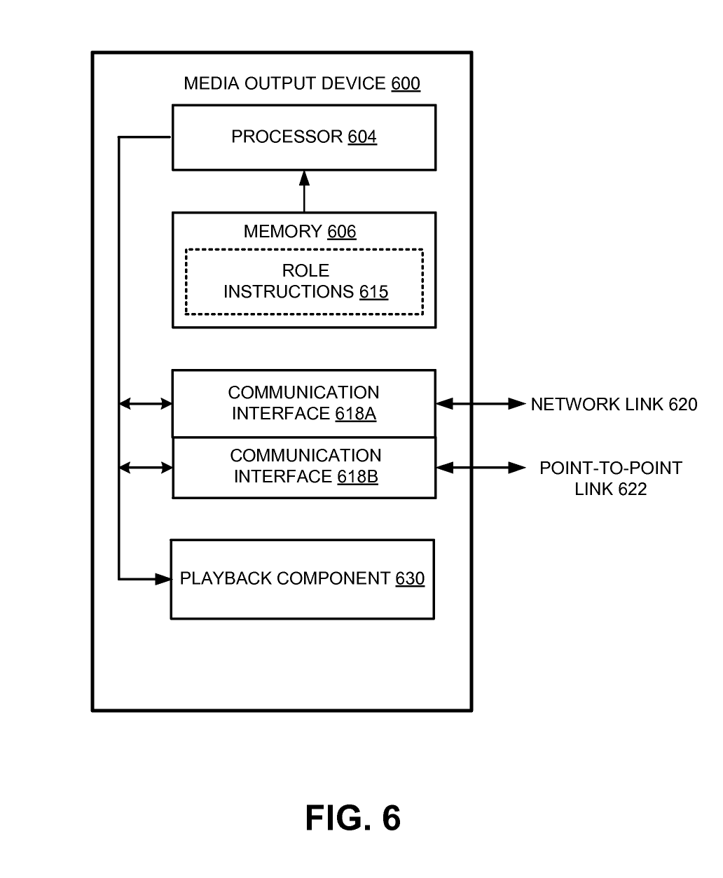

FIG. 6 is a block diagram that illustrates a network-enabled media output device upon which aspects described herein can be implemented. For example, in the context of FIG. 1C, media output device 100 may be implemented using a network-enabled media output device FIG. 6.

In an example, media output device 600 includes processor 604, memory 606 (including non-transitory memory), multiple communication interfaces 618, and a playback component 630. In an example shown, a first communication interface 618A enables the media output device 600 to establish a network link (e.g., over Wi-Fi) with a resource or with one or more other devices (e.g., other media output devices). The second communication interface 618B enables the media output device 600 to establish a point-to-point link 622 (e.g., Bluetooth) with another device or resource, such as a media source device. The media output device 600 may include a processor 604 for processing instructions. The media output device 600 may also include memory 606 for storing information and instructions to be executed by processor 604. The memory 606 can used for storing temporary variables or other intermediate information during execution of instructions to be executed by processor 604. The media output device 600 can also store static information and instructions for processor 604.

The communication interfaces 618A, 618B can include ports for different forms of connectivity, including, for example, a Bluetooth communication port and a Wi-Fi communication port. At least one of the communication interfaces 618 can enable the media output device 600 to communicate with one or more networks through use of a network link 620 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, Bluetooth and wireless data networks (e.g., Wi-Fi and Wi-Max networks).

The media output device 600 can be used to implement at least some examples provided herein. For example, the processor 604 and memory 606 can store instructions (e.g., role instructions 615, as described below) for implementing the server application 150, stream converter 116, buffer component 130, timing logic 120, device interface logic 126, and stream link generator 118. The communication interfaces 618A and 618B can also be used to implement the point-to-point interface 124 and the network interface 128.

According to examples, the memory 606 stores instructions for enabling the processor 604 to implement one or more roles (“role instructions 615). Examples of roles which can be implemented using the role instructions 615 include the roles of operating as receiver device that connects to a media source device using a point-to-point connection, a leader device for a group of media output devices, or a proxy for a leader device.

The processor 604 can also signal or control the playback component 630 to generate media content. The media content can originate from a source media device, connected over the point-to-point link 622 using the communication interface 618B. In such an implementation, the processor 604 can execute select role instructions 615 to convert a format of the incoming media stream from the source device, and then transmit the converted media stream over the network link 620 using the communication interface 618A. In one implementation, the processor 604 can control transmission of the converted media stream, while signaling the converted media stream to the playback component 630, in order to generate synchronized media content.

In variations, the processor 604 can selectively execute the role instructions 615 to receive a converted media stream from another media output device which operates as a leader. The playback component 630 can receive the converted media stream and generate media content as output under the control of another media output device acting as the leader.

Examples described herein are related to the use of media output device 600 for implementing the techniques described herein. According to some examples, the techniques can be performed by media output device 600 in response to processor 604 executing one or more sequences of one or more instructions contained in the memory 606. Execution of the sequences of instructions (including the role instructions 615) contained in memory 606 can cause the processor 604 to perform an example method such as described with FIG. 5A and FIG. 5B. In alternative aspects, hard-wired circuitry may be used in place of or in combination with software instructions to implement aspects described herein. Thus, aspects described are not limited to any specific combination of hardware circuitry and software.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an embodiment, can be combined with other individually described features, or parts of other aspects. Thus, absence of describing combinations should not preclude the inventor(s) from claiming rights to such combinations.

What is claimed is:

1. A method for operating a media output device, the method comprising:
connecting to a source device using a point-to-point communication medium, to receive a media content stream;
converting the media content stream from a format of the point-to-point communication medium to a format of a second communication medium;
identifying one or more other media output devices which are interconnected over the second communication medium to form, in combination with the media output device, a group of media output devices;
implementing an output configuration for the group of media output devices, the output configuration specifying one of the media output devices as a leader device; and
initiating transmission of the converted media content stream from the leader device, in the format of the second communication medium, for synchronized playback of the media content stream on the group of media output devices.

2. The method of claim 1, wherein implementing the output configuration includes selecting one of the media output devices from the group of media output devices as the leader device.

3. The method of claim 2, wherein the leader device is selected to be different than the media output device, and wherein initiating transmission of the media content stream includes transmitting the converted media content stream from the media output device to the leader device.

4. The method of claim 3, wherein selecting the leader device includes transmitting a link from the media output device to the leader device to trigger the leader device to access the converted media content stream from the media output device and to transmit the converted media content stream from the leader device to each of the media output devices of the group.

5. The method of claim 3, wherein selecting the leader device includes transmitting a link from the leader device to at least one other media output device of the group to trigger the at least one other media output device to access the converted media content stream from a location specified by the link.

6. The method of claim 1, wherein initiating transmission of the converted media content stream includes transmitting a link to each of the other media output devices to trigger the other media output devices to access the converted stream from the media output device.

7. The method of claim 6, wherein one of the other media output devices is selected as the leader device.

8. The method of claim 2, wherein the leader device is selected to be the same as the media output device, and wherein initiating transmission of the media content stream includes transmitting, as the leader device, the converted media content stream from the media output device to each of the media output devices of the group.

9. The method of claim 8, wherein as the leader device, the media output device controls timing parameters for synchronized playback of the media content from the group of media output devices.

10. The method of claim 8, wherein as the leader device, the media output device performs operations for at least one of playback control by the group of media output devices, or implementation of buffer control logic to monitor an amount of buffer data on each media output device of the group.

11. The method of claim 2, further comprising initiating a server application on the leader device.

12. The method of claim 2, wherein implementing the output configuration includes selecting one of the media output devices of the group as the leader device based on a capability of the selected media output device.

13. The method of claim 12, wherein the capability corresponds to the selected media output device having a digital signal processor (DSP).

14. The method of claim 2, wherein implementing the output configuration includes selecting one of the media output devices as the leader device based on an amount of bandwidth that is available to the selected media output device as compared to other media output devices of the group.

15. The method of claim 2, wherein implementing the output configuration includes selecting one of the media output devices as the leader based on a user preference.

16. The method of claim 1, wherein implementing the output configuration includes detecting another media output device of the group as having previously been selected as the leader device, and then causing a switch with the detected media output device that was previously selected as the leader device, so that the media output device becomes the leader device.

17. The method of claim 1, wherein the point-to-point communication medium is implemented using a Bluetooth protocol, and wherein the second communication medium is implemented using an 802.11 protocol.

18. A media output device comprising:
a first communication interface to connect with one or more devices over a point-to-point communication medium;
a second communication interface to interconnect with one or more devices over a second communication medium;
one or more processors;
wherein the one or more processors operate to:
connect to a source device using the first communication interface to receive a media content stream;
convert the media content stream from a format of the point-to-point communication medium to a format of the second communication medium;
identify one or more media output devices which are interconnected over the second communication medium to form, in combination with the media output device, a group of media output devices;
implement an output configuration for the group of media output devices, the output configuration specifying one of the media output devices as a leader device; and
initiate transmission of the converted media content stream from the leader device, in the format of the second communication medium, for synchronized playback of the media content stream on the group of media output devices.

19. The media output device of claim 18, wherein the one or more processors implement the output configuration by selecting one of the media output devices from the group of media output devices as the leader device.

20. The media output device of claim 19, wherein the one or more processors select the leader device to be different than the media output device, and wherein the one or more processors initiate transmission of the media content stream by transmitting the converted media content stream from the media output device to the selected leader device.

21. The media output device of claim 20, wherein the one or more processors transmit a link from the media output device to one of the other media output devices that is selected as the leader device to trigger the leader device to access the converted media content stream from the media output device and to transmit the converted media content stream from the leader device to each of the media output devices of the group.

22. The media output device of claim 20, wherein the one or more processors transmit a link from the leader device to at least one other media output device of the group to trigger the at least one other media output device to access the converted media content stream from a location specified by the link.

23. The media output device of claim 18, wherein the one or more processors transmit a link to each of the other media output devices to trigger the other media output devices to access the converted stream from the media output device.

24. The media output device of claim 23, wherein one of the other media output devices is selected as the leader device.

25. The media output device of claim 19, wherein when the media output device is selected as the leader device, the one or more processors initiate transmission of the media content stream by transmitting, as the leader device, the converted media content stream from the media output device to each of the media output devices of the group.

26. The media output device of claim 19, wherein when the media output device is selected as the leader device, the one or more processor perform operations for at least one of playback control by the group of media output devices, or implementation of buffer control logic to monitor an amount of buffer data on each device.

27. The media output device of claim 19, wherein the one or more processors initiate a server application on the leader device.

28. The media output device of claim 19, wherein the one or more processors implement the output configuration by selecting one of the media output devices of the group as the leader device based on at least one of a capability of the selected media output device, or an amount of bandwidth that is available to the selected media output device as compared to other media output devices of the group.

29. A non-transitory computer-readable medium that stores instructions, which when executed by one or more processors of a media output device, cause the media output device to perform operations that include:
connecting to a source device using a point-to-point communication medium, to receive a media content stream;
converting the media content stream from a format of the point-to-point communication medium to a format of a second communication medium;
identifying one or more other media output devices which are interconnected over a second communication medium to form, in combination with the media output device, a group of media output devices;
implementing an output configuration for the group of media output devices, the output configuration specifying one of the media output devices as a leader device; and
initiating transmission of the converted media content stream from the leader device, in the format of the second communication medium, for synchronized playback of the media content stream on the group of media output devices.

30. A media output device comprising:
means for connecting to a source device using a point-to-point communication medium, to receive a media content stream;
means for converting the media content stream from a format of the point-to-point communication medium to a format of a second communication medium;
means for identifying one or more other media output devices which are interconnected over a second communication medium to form, in combination with the media output device, a group of media output devices;
means for implementing an output configuration for the group of media output devices, the output configuration specifying one of the media output devices as a leader device; and
means for initiating transmission of the converted media content stream from the leader device, in the format of the second communication medium, for synchronized playback of the media content stream on the group of media output devices.
